(19) United States
(12) Patent Application Publication
(10) Pub. No.: US 2008/0092660 A1
(43) Pub. Date: Apr. 24, 2008

(54) Multi-line beamforming extention using sub-arrays

(75) Inventor: Thomas J. Hunt, Pelham, NH (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/571,400

(22) PCT Filed: Jun. 28, 2005
(86) PCT No.: PCT/IB05/52148

§ 371 Date: Dec. 28, 2006

Related U.S. Application Data
(60) Provisional application No. 60/584,204, filed on Jun. 30, 2004.
(60) Provisional application No. 60/626,398, filed on Nov. 9, 2004.

(51) Int. Cl. G10K 11/00

(52) U.S. Cl. 73/625

(57) ABSTRACT

Provided is a multi-line beamformer (100) that generates a multi-line output (141-144) by positioning multiple receive beams within the area covered by a transmit beam. N multi-line beams are generated using N/M fully capable beamformers (111-116) by producing partial sums (121-128) from sub-groups (105-108) of the elements of the beamformers (111-116), where M depends upon a per channel element spacing measured in wavelengths of the imaging frequency.

This disclosure pertains generally to microbeamforming in an ultrasound system and, more specifically, to a method of increasing resolution of an image by means of novel post-processing techniques.

A phased array ultrasound imaging system directs ultrasound energy pulses into an object, typically the human body, and creates an image of the body based upon the energy reflected from tissue and structures of the body. The transmitted energy can be focused along “scan lines” by means of “beamforming,” i.e. a technique that focuses an array of sensors along a scan line by applying various time delays to the output of individual sensors.

Most commercially available phased array ultrasound imaging systems today use a technique known as “multi-line beamforming” to improve their image frame update rates.

This technique relies on the fact that, although transmitted energy can only be focused at a single point along a scan line, a receiver can be dynamically focused at every point along the line. Thus, multiple receive beams can be positioned within an area covered by a transmit beam.

The most common techniques for implementing such a “N-degree multi-line receive” beamformer is to generate N copies of a single line beamformer and operate the copies in parallel or to build hardware that is N-times faster then required by a single-line beamformer and run the hardware N times per transmit event. An example of this technique is described in a patent by Lipschutz (U.S. Pat. No. 5,469,851).

This disclosure provides such a system and method to generate N multi-line beams using only N/M fully capable beamformers with the ability to produce partial sums from sub-groups of elements. M depends upon a per channel element spacing of a transducer measured in wavelengths of the imaging frequency. The disclosed subject matter reduces both the cost and power requirements of conventional digital multi-line beamforming techniques by reducing the number of necessary beamformers by a factor of M.

These and other advantages, as well as additional inventive features, will be apparent from the present disclosure.

For a more complete understanding of the present disclosure, and the advantages thereof, reference is now made to the following brief descriptions taken in conjunction with the accompanying figures, in which like reference numerals indicate like features.

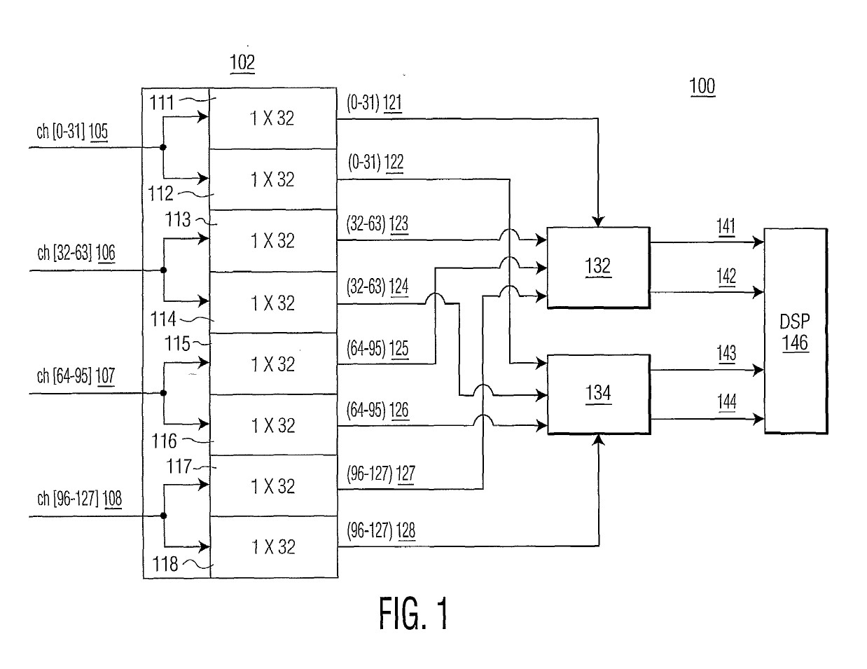

FIG. 1 illustrates an exemplary beamformer that employs the claimed subject matter.

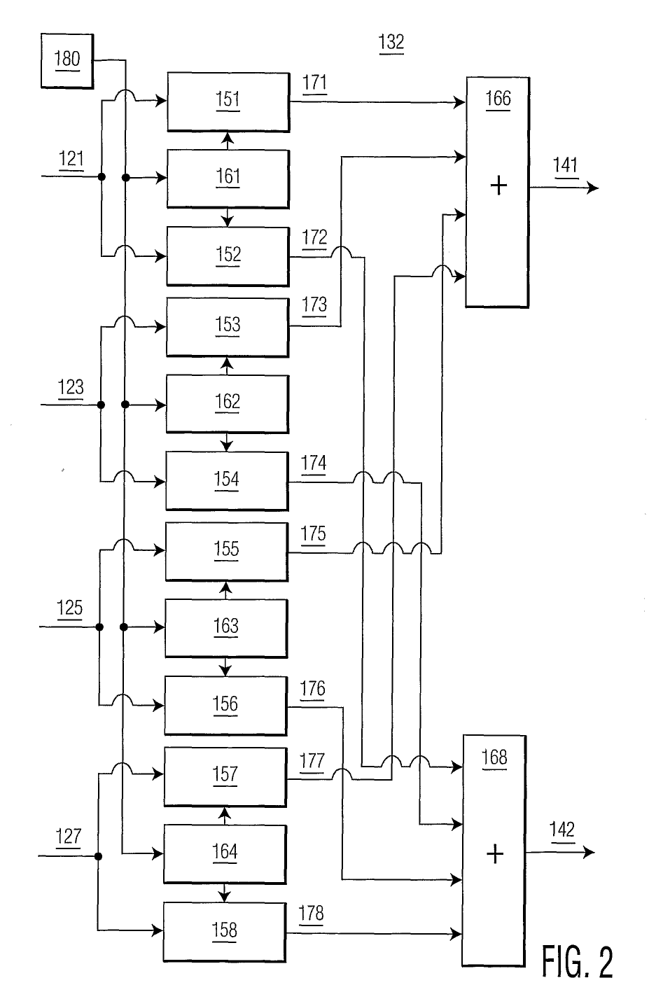

FIG. 2 illustrates a multi-line extender component of the beamformer system introduced in FIG. 1.

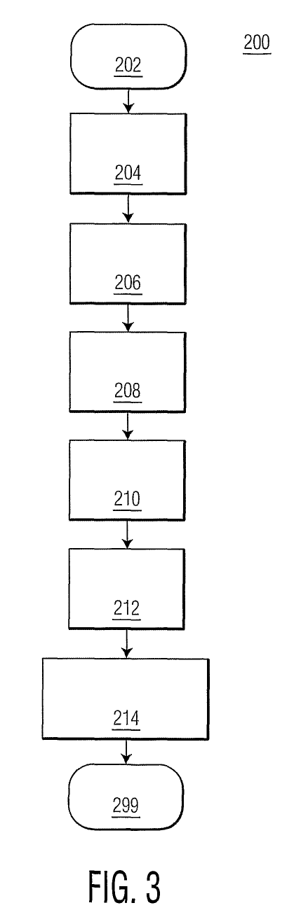

FIG. 3 is a flowchart of a process that implements an embodiment of the claimed subject matter.

This disclosure provides examples of an ultrasound beamformer that sub-groups receiver channels, processes each sub-channel multiple times to produce multiple scan lines from a single set of receiver signals. In general, the disclosed subject matter generates N multi-line scan lines, or “beams,” using N/M fully capable beamformers. M depends upon a per channel receiver element spacing of a transducer measured in wavelengths of the imaging frequency. The examples described below employ one hundred twenty-eight (128) channel phased array beamformers, although the technique is applicable to any number of channels.

Other aspects, objectives and advantages of the invention will become more apparent from the remainder of the detailed description when taken in conjunction with the accompanying figures.

FIG. 1 illustrates an exemplary beamforming system 100 that employs the claimed subject matter. In this example, N is four (4) and each sub-group consists of sixteen (16) channels. M can be as large as two (2) without producing a significant error in the beamforming. To reduce both the cost and power requirements of conventional digital multi-line beamformering systems, the disclosed technology reduces the number of necessary beamformers in such systems by a factor of M.

Beamformer system 100 includes a one hundred twenty-eight (128) channel receiver 102 that receives energy transmitted from one or more transmitters (not shown).

Throughout this specification, specific channels and sub-groups of channels are referred to by means of numbers within square brackets (“[ ]”) e.g. channels 0-7 are referred to as “ch[0-7] and channels 0, 7, 15 and 23 are referred to as ch[0,7,15,23].”

Channels ch[0-127] of receiver 102 are subdivided into four (4) thirty-two (32) channel sub-groups, with each sub-group processed by 2 single-scan line (1X) beamformers. More specifically, channels ch[0-31] 105 are processed by 1X beamformers 111 and 113, channels ch[32-63] 106 are processed by 1X beamformers 113 and 114, channels ch[64-95] 107 are processed by 1X beamformers 115 and 116, and channels ch[96-127] 108 are processed by 1X beamformer 117 and 118.

Beamformers 111, 113, 115 and 117 output signals 121, 123, 125 and 127, respectively, to a multi-line extender 132. Multi-line extender 132 is described in more detail below in conjunction with FIG. 2. The output of multi-line extender 132 includes two (2) beamformer signals 141 and 142, which are transmitted to a digital signal processor 146 for further processing. Beamformer signals 141 and 142 represent two (2) distinct scan lines generated from the 128 channels ch[0-127] of receiver 102.

In a similar fashion, beamformers 112, 114, 116 and 118 output signals 122, 124, 126 and 128, respectively, to a multi-line extender 134. Multi-line extender 134 is described in more detail below in conjunction with FIG. 2. The output of multi-line extender 134 includes two (2) beamformer signals 143 and 144, which are transmitted to digital signal processor 146 for further processing. Beamformer signals 143 and 144 represent two (2) distinct scan lines generated from the 128 channels ch[0-127] of receiver 102.

Throughout the rest of this specification signal 141 is referred to as “Beam A,” signal 142 as “Beam B,” signal 143 as “Beam C” and signal 144 as “Beam D.” By generating four (4) distinct scan lines from receiver 102, system 100 is able to increase the resolution of the resultant image with less hardware than a typical multi-line beamforming system. This feature is particularly significant in beamforming systems designed to render three dimension (“3D”) images in real-time.

FIG. 2 illustrates in more detail multi-line extender 132 of beamformer system 100, both of which were introduced above in conjunction with FIG. 1. Input to extender 132 includes channels ch[0-127], organized into subgroups 121, 123, 125 and 127 (FIG. 1). Outputs of extender 132 include two (2) beamformer signals, beam A 141 and beam B 142 (FIG. 1).

Sub-groups 121, 123, 125 and 127 are each transmitted to two (2) delay blocks. Specifically, sub-group 121 is transmitted to delay sub-modules 151 and 152, sub-group 123 is transmitted to delay sub-modules 153 and 154, sub-group 125 is transmitted to delay sub-modules 155 and 156 and sub-group 127 is transmitted to delay sub-modules 157 and 158.

Each of delay sub-modules 151-158 are controlled by one of delay control modules (DCMs) 161-164, which are in turn controlled by a master delay control (MDC) module 180. Specifically, delay sub-modules 151 and 152 are controlled by DCM 161, delay sub-modules 153 and 154 are controlled by DCM 162, delay sub-modules 155 and 156 are controlled by DCM 163, and delay sub-modules 157 and 158 are controlled by DCM 164.

Delay sub-modules 151-158 are each controlled by their respective DCMs 161-164 to adjust the amount of delay applied to each sub-group 121, 123, 125 and 127. The specific delay applied is a function of a desired imaging depth. DMCs 151-158 produce signals 171-178, respectively.

Exemplary summing modules 166 and 168 combine the outputs from respective sub-groups to form fully beamformed results Beam A 141 and Beam B 142. Specifically, summing module 166 combines signals 171, 173, 175 and 177 to produce Beam A 141 and summing module 168 combines signals 172, 174, 176 and 178 to form Beam B 142.

In this manner, beamformer system 100 generates four (4) distinct scan lines from receiver 102, i.e. Beam A 141, Beam B 142, Beam C 143 and Beam D 144, increasing the resolution of system 100 with less hardware than a typical beamforming system. As explained above in conjunction with FIG. 1, this technique is particularly significant in beamforming systems designed to render three dimension (“3D”) images in real-time because multiple scan lines are produced using the same transmitter and receiver hardware as a typical single scan line beam forming system.

The following table shows the estimated time delay error of a beamforming system with, in this case, a forty (40) channel receiver (not shown). The forty (40) channels are sub-grouped into five (5) groups with eight (8) channels per group. In this example, the fixed angle of the generated beam is equal to zero degrees (0°) and the focal depth is equal to eighty (80) millimeters (mm). The actual angle is two degrees (2°) and the actual depth is eighty (80) mm. Channel pitch is 0.250 mm, the sound speed is 0.650 usec/mm, the fully capable beamformer delay quantization is 0.006 usec and the multiline extender delay quantization is equal 0.025 usec.

| | | Group | Group | Sub- | | Perfect | |
|---|---|---|---|---|---|---|---|
| | | Offset | Delay | Delay | Total | Delay | |
| Channel | Group # | (mm) | (usec) | (usec | Delay | (usec) | Error |
| 0 | 1 | 1 | 0.024 | 0.000 | 0.024 | 0.000 | −0.024 |
| 1 | 1 | 1 | 0.024 | 0.000 | 0.024 | 0.012 | −0.012 |
| 2 | 1 | 1 | 0.024 | 0.000 | 0.024 | 0.018 | −0.006 |
| 3 | 1 | 1 | 0.024 | 0.000 | 0.024 | 0.024 | 0.000 |
| 4 | 1 | 1 | 0.024 | 0.000 | 0.024 | 0.030 | 0.006 |
| 5 | 1 | 1 | 0.024 | 0.000 | 0.024 | 0.036 | 0.012 |
| 6 | 1 | 1 | 0.024 | 0.000 | 0.024 | 0.048 | 0.024 |
| 7 | 1 | 1 | 0.024 | 0.000 | 0.024 | 0.054 | 0.030 |
| 8 | 2 | 3 | 0.102 | −0.025 | 0.077 | 0.066 | −0.011 |
| 9 | 2 | 3 | 0.102 | −0.025 | 0.077 | 0.078 | 0.001 |
| 10 | 2 | 3 | 0.102 | 0.000 | 0.102 | 0.090 | −0.012 |
| 11 | 2 | 3 | 0.102 | 0.000 | 0.102 | 0.096 | −0.006 |
| 12 | 2 | 3 | 0.102 | 0.000 | 0.102 | 0.108 | 0.006 |
| 13 | 2 | 3 | 0.102 | 0.000 | 0.102 | 0.120 | 0.018 |
| 14 | 2 | 3 | 0.102 | 0.025 | 0.127 | 0.138 | 0.011 |
| 15 | 2 | 3 | 0.102 | 0.025 | 0.127 | 0.150 | 0.023 |
| 16 | 3 | 5 | 0.216 | −0.025 | 0.191 | 0.162 | −0.029 |
| 17 | 3 | 5 | 0.216 | −0.025 | 0.191 | 0.174 | −0.017 |
| 18 | 3 | 5 | 0.216 | −0.025 | 0.191 | 0.192 | 0.001 |
| 19 | 3 | 5 | 0.216 | 0.000 | 0.216 | 0.204 | −0.012 |
| 20 | 3 | 5 | 0.216 | 0.000 | 0.216 | 0.222 | 0.006 |
| 21 | 3 | 5 | 0.216 | 0.025 | 0.241 | 0.240 | −0.001 |
| 22 | 3 | 5 | 0.216 | 0.025 | 0.241 | 0.258 | 0.017 |
| 23 | 3 | 5 | 0.216 | 0.050 | 0.266 | 0.270 | 0.004 |
| 24 | 4 | 7 | 0.354 | −0.050 | 0.304 | 0.288 | −0.016 |
| 25 | 4 | 7 | 0.354 | −0.025 | 0.329 | 0.306 | −0.023 |
| 26 | 4 | 7 | 0.354 | −0.025 | 0.329 | 0.330 | 0.001 |
| 27 | 4 | 7 | 0.354 | 0.000 | 0.354 | 0.348 | −0.006 |
| 28 | 4 | 7 | 0.354 | 0.000 | 0.354 | 0.366 | 0.012 |
| 29 | 4 | 7 | 0.354 | 0.025 | 0.379 | 0.384 | 0.005 |
| 30 | 4 | 7 | 0.354 | 0.025 | 0.379 | 0.408 | 0.029 |
| 31 | 4 | 7 | 0.354 | 0.050 | 0.404 | 0.426 | 0.022 |
| 32 | 5 | 9 | 0.528 | −0.050 | 0.478 | 0.450 | −0.028 |
| 33 | 5 | 9 | 0.528 | −0.050 | 0.478 | 0.474 | −0.004 |
| 34 | 5 | 9 | 0.528 | −0.025 | 0.503 | 0.498 | −0.005 |
| 35 | 5 | 9 | 0.528 | 0.000 | 0.528 | 0.516 | −0.012 |
| 36 | 5 | 9 | 0.528 | 0.000 | 0.528 | 0.540 | 0.012 |
| 37 | 5 | 9 | 0.528 | 0.025 | 0.553 | 0.564 | 0.011 |
| 38 | 5 | 9 | 0.528 | 0.050 | 0.578 | 0.594 | 0.016 |
| 39 | 5 | 9 | 0.528 | 0.075 | 0.603 | 0.618 | 0.015 |

The significance of that table above is that the error rates are less than or very close to the tolerance of the system (in this case 0.25 usec), and are thus virtually undetectable.

FIG. 3 is a flowchart of a process 200 that implements an embodiment of the claimed subject matter. Process 200 starts in a “Begin” block 202 and proceeds immediately to a “Receive Signals” block 204 during which signals from a group of transmitters in a beamforming system, such as beamforming system 100 (FIG. 1), are received. During a “Group Signals” block 206, the signals received during block 204 are grouped into subgroups, with each subgroup typically representing transmitters that are adjacent to each other. In the example described above in conjunction with FIGS. 1 and 2, there are four (4) subgroups although other numbers of subgroups may be employed.

During a “Define Scan Lines” block 208, depending upon the number of transducers and subgroups, a number of distinct scan lines that can be generated from the available data is determined. In the example of FIGS. 1 and 2, two (2) distinct scan lines are defined although, again this number may vary depending upon the amount of transducers and subgroups. During a “Process Subgroups” block 210, each signal received during block 204 of each subgroup defined in block 206 is split so that there is a distinct signal for each scan line defined in block 208. In other words, using the example above, each signal is duplicated so that each scan line can be composed of copies of all the signals.

Then, each signal corresponding to each scan line is time delayed by an appropriate amount to generate the respective scan line.

During a “Correlate Signals” block 212, the time delayed signals from each subgroup are correlated based upon their respective scan lines and the signals representing each scan line are summed together of produce each scan line. During a “Generate Multi-Line Output” block 214, the scan lines are produced based upon the time-delayed and summed groups of signals, each scan line composed of information from each signal. In this manner, multiple scan lines are produced from a single set of signals. Finally, in an “End” block 299, process 200 is complete.

In the context of this document, a “memory” or “recording medium” can be any means that contains, stores, communicates, propagates, or transports the program and/or data for use by or in conjunction with an instruction execution system, apparatus or device.

Memory and recording medium can be, but are not limited to, an electronic, magnetic, optical, electromagnetic, infrared or semiconductor system, apparatus or device. Memory an recording medium also includes, but is not limited to, for example the following: a portable computer diskette, a random access memory (RAM), a read-only memory (ROM), an erasable programmable read-only memory (EPROM or flash memory), and a portable compact disk read-only memory or another suitable medium upon which a program and/or data may be stored.

In addition, the methods of the disclosed invention can be implemented in software, hardware, or a combination of software and hardware. The hardware portion can be implemented using specialized logic; the software portion can be stored in a memory and executed by a suitable instruction execution system such as, but not limited to, a microprocessor.

The use of the terms “a” and “an” and “the” and similar referents in the context of describing embodiments of the invention (especially in the context of the following claims) are to be construed to cover both the singular and the plural, unless otherwise indicated herein or clearly contradicted by context. The terms “comprising, ” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. For example, different numbers of channels, delay sub-modules, summing sub-modules and output beams may be implemented. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method of multi-line beamforming using sub-arrays, comprising:
receiving a plurality of signals, each signal corresponding to a unique transducer of an array of transducers;
grouping the transducers of the plurality of transducers and the corresponding signals into sub-arrays, wherein the transducers within each sub- array are adjacent;
defining two or more distinct scan lines corresponding to an image;
processing each sub-array of signals such that each sub-array produces two or more beams, each beam corresponding to a different scan line of the two or more scan lines;
correlating the signals into sub-groups, each sub-group corresponding to a different scan line of the two or more scan lines;
summing the component signals within each of the sub-groups; and
generating a multi-line output corresponding to the image, wherein each line of the multi-line output corresponds to a particular scan line corresponding to the corresponding new sub-group.

2. The method of claim 1, wherein the array of transducers is a one hundred twenty-eight (128) channel phased array beamformer.

3. The method of claim 2, wherein there are sixteen (16) sub-arrays.

4. The method of claim 3, wherein each sub-array of the sixteen (16) sub-arrays includes eight (8) channels.

5. The method of claim 4, wherein the multi-line output is a four (4) line output.

6. The method of claim 1, wherein the transducers of the array of transducers are on a lambda/2 pitch.

7. The method of claim 1, further comprising optimizing the output of the beamformer based upon a per channel spacing of the transducers measured in wavelengths of the imaging frequency.

8. A multi-line beamforming system, comprising:
an array of transducers, wherein each transducer generates a signal corresponding to a reflected signal;
logic for grouping the transducers of the array of transducers and the corresponding signals into sub-arrays, wherein the transducers within each sub- array are adjacent;
two or more beams, each beam corresponding to a particular sub-array and a corresponding, unique scan line;
logic for correlating the signals into sub-groups, each sub-group corresponding to a different beam;
a summing module for summing the component signals within each of the sub-groups; and
a multi-line output, wherein each line of the multi-line output corresponds to a different scan line.

9. The system of claim 8, wherein the array of transducers is a one hundred twenty-eight (128) channel phased array beamformer.

10. The system of claim 9, wherein there are sixteen (16) sub-arrays.

11. The system of claim 10, wherein each sub-array of the sixteen (16) sub-arrays includes eight (8) channels.

12. The system of claim 11, wherein the multi-line output is a four (4) line output.

13. The system of claim 8, wherein the transducers of the array of transducers are on a lambda/2 pitch.

14. The system of claim 8, further comprising logic for optimizing the output of the beamforming system based upon a per channel spacing of the transducers measured in wavelengths of the imaging frequency.

15. A computer programming product, comprising:
a memory,
logic, stored on the memory, for receiving a plurality of signals, each signal corresponding to a unique transducer of an array of transducers;
logic, stored on the memory, for grouping the transducers of the plurality of transducers and the corresponding signals into sub-arrays, wherein the transducers within each sub-array are adjacent;
logic, stored on the memory, for defining two or more distinct scan lines corresponding to an image;
logic, stored on the memory, for processing each sub-array of signals such that each sub-array produces two or more beams, each beam corresponding to a different scan line of the two or more scan lines;
logic, stored on the memory, for correlating the signals into sub-groups, each sub-group corresponding to a different scan line of the two or more scan lines;
logic, stored on the memory, for summing the component signals within each of the sub-groups; and
logic, stored on the memory, for generating a multi-line output corresponding to the image, wherein each line of the multi-line output corresponds to a particular scan line corresponding to the corresponding new sub-group.

16. The computer programming product of claim 15, wherein the array of transducers is a one hundred twenty-eight (128) channel phased array beamformer.

17. The computer programming product of claim 16, wherein there are sixteen (16) sub-arrays, each sub-array of the sixteen (16) sub-arrays including eight (8) channels.

18. The computer programming product of claim 17, wherein the multi-line output is a four (4) line output.

19. The computer programming product of claim 15, wherein the transducers of the array of transducers are on a lambda/2 pitch.

20. The computer programming product of claim 5, further comprising logic, stored on the memory, for optimizing the output of the beamformer based upon a per channel spacing of the transducers measured in wavelengths of the imaging frequency.
